(19) United States
(12) Patent Application Publication
(10) Pub. No.: US 2015/0363514 A1
(43) Pub. Date: Dec. 17, 2015

(54) CAD Data Processing Device and Processing Method

(71) Applicant: HITACHI, LTD., Chiyoda-ku, Tokyo (JP)

(72) Inventor: Tomotoshi ISHIDA, Tokyo (JP)

(21) Appl. No.: 14/761,513

(22) PCT Filed: Feb. 8, 2013
(86) PCT No.: PCT/JP2013/052980

§ 371 Date: Jul. 16, 2015

(51) Int. Cl. G06F 17/50

(52) U.S. Cl. CPC G06F 17/50; G06F 17/5004

(57) ABSTRACT

The present invention provides a processing device and a processing method capable of optimization of CAD data merge and of minimizing an omission and an error in the merging operation. The processing device for three-dimensional CAD data having a plurality of elements and attribute data associated with each of the plurality of elements includes means for reading a plurality of pieces of CAD data, attribute extraction means for extracting the attribute data from first CAD data, correspondence relation extraction means for extracting a correspondence relation using positional information included in the first CAD data and second CAD data, attribute attachment means for attaching the attribute data extracted from the first CAD data to the second CAD data based on the extracted correspondence relation, and means for outputting the data provided with the attribute data.

### TECHNICAL FIELD

The present invention generally relates to a device and a method of assisting designing of various industrial products. The present invention specifically relates to a device and a method of assisting an operation on a single product jointly performed by a plurality of persons in charge.

### BACKGROUND ART

Designing of various products handling three-dimensional shape data on a CAD system and the like is sometimes performed jointly by a plurality of persons in charge.

When designing a structure such as a plant and a building, as the design progresses from an outline design to a basic design and then to a detailed design, there are cases where respective designs are performed by different designers, in which each designer takes charge of the detailed design with respect to each part, and the like. In such cases, CAD data created in an upstream designing may be passed to a downstream designer, and the downstream designer may create more detailed CAD data with reference thereto. At this time, an identical CAD system or different ones may be used for designing. Not only in a case of using different CAD systems but also in a case of using an identical CAD system, in the downstream designing, the data from the upstream designing may be sometimes modified for refinement, but often new data is recreated. Upon completion of the downstream detailed design, it is required to merge (compile) CAD data created separately for assisting parts production, assembly, and construction.

The CAD data includes attribute data accompanying shape data. The attribute data is constituted by a character string and the like which can indicate its name, part number, material, designer name, date of design, date of production, date of assembly, date of construction, and the like. In the design procedure described above, such usages are common as to record the date of construction that is important for the entire process as an attribute because the whole plan is the purpose of the upstream designing, or to record the date of production of a part as an attribute because the designing of each part is the purpose of the downstream detailed designing. If the CAD data created separately in the downstream detailed designing is merged as it is in this state, it will not be included in the data that has merged the date of construction recorded during the upstream designing. In order to avoid this, it is necessary to input again the attribute data that was recorded in the CAD data from the upstream designing at the time of the detailed designing or merging.

When performing re-input of the attribute data, such operations are required as to firstly activate the CAD system used for the upstream designing, to read and display the CAD data from the upstream designing, to refer to an attribute of an element (part), then to activate the CAD system used for the downstream detailed designing, to read the CAD data of the detailed design, to identify the corresponding element (part), and to newly input or add original attribute data to the identified element.

Until now, there has not been any device or method for automatically performing this operation.

Patent Literature 1 discloses a method of extracting attribute data from CAD data and displaying only the attribute data on a separate window.

Patent Literature 2 discloses a method of comparing two pieces of CAD data to determine whether the shape and position are identical. It also discloses a method of expressing the difference if there is any difference. It further discloses a method of using identity of attribute data attached to each determination of the identity.

### CITATION LIST

### Patent Literature

Patent Literature 1: Japanese Unexamined Patent Application Publication No. 2008-59330

Patent Literature 2: Japanese Patent Publication No. 4860272

### SUMMARY OF INVENTION

### Technical Problem

An operation of merging created CAD data after a plurality of designers have performed the outline designing, the basic designing, the detailed designing and the like separately is cumbersome. Especially the processing of merging the attribute data cannot be automatically performed although it is a simple operation. This is because it is difficult to identify the corresponding element. In the outline design, the basic design, and the detailed design, the CAD data show different shapes. When not only elements with different shapes but also elements created as a single element (part) in one designing are deployed as a plurality of elements (parts) in another design process, the situation can be reversed. Thus, even when determining whether the corresponding element cannot be found by simply determining whether the shape and position are identical, it will result in the fact that most elements are different. Moreover, even if a name or a part number is attached to each element, the number of the elements (parts) is subject to change, and therefore it is not possible to simply apply an identical name or part number to the corresponding element.

The present invention has been made in the light of the above, and aims to provide a processing device and a processing method capable of optimization of CAD data merge and of minimizing an omission and an error in the merging operation.

### Solution to Problem

A processing device for three-dimensional CAD data having a plurality of elements and attribute data associated with each of the plurality of elements, including: means for reading a plurality of pieces of CAD data, attribute extraction means for extracting the attribute data from first CAD data, correspondence relation extraction means for extracting a correspondence relation using positional information included in the first CAD data and second CAD data, attribute attachment means for attaching the attribute data extracted from the first CAD data to the second CAD data based on the extracted correspondence relation, and means for outputting the data provided with the attribute data.

### Advantageous Effects of Invention

According to the present invention, it is possible to provide a processing device and a processing method capable of optimization of CAD data merge and of minimizing an omission and an error in the merging operation.

### BRIEF DESCRIPTION OF DRAWINGS

FIG. 1 is a diagram showing an outline of a processing device and peripheral devices.

FIG. 2 is a diagram showing typical CAD data in each step of outline, basic, and detailed designing.

FIG. 3 is a diagram visually showing a state of typical CAD data provided with attribute data.

FIG. 4 is a diagram showing an example of a table format of basic design data and the data stored in a basic design data storage unit.

FIG. 5 is a diagram showing an example of a table format of detailed design data and the data stored in a detailed-design data storage unit.

FIG. 6 is a diagram showing an example of a table format of element attribute data and the data stored in an element attribute data storage unit.

FIG. 7 is a diagram showing an example of a table format of correspondence relation data and the data stored in a correspondence relation data storage unit.

FIG. 8 is a flow diagram of a process performed by a processing device.

FIG. 9 is a flow diagram of a process performed by a correspondence relation extraction unit.

FIG. 10 is a flow diagram of a process performed by an attribute attachment unit.

FIG. 11 is a diagram showing an example of a table format of correspondence relation data and the data stored in a merged CAD data storage unit.

FIG. 12 is a diagram of a display screen where the merged CAD data is output and displayed.

### DESCRIPTION OF EMBODIMENTS

Hereinafter, the present invention is described using an embodiment with reference to drawings.

### First Embodiment

Before describing an embodiment, a typical process and object of design used in the description will be described.

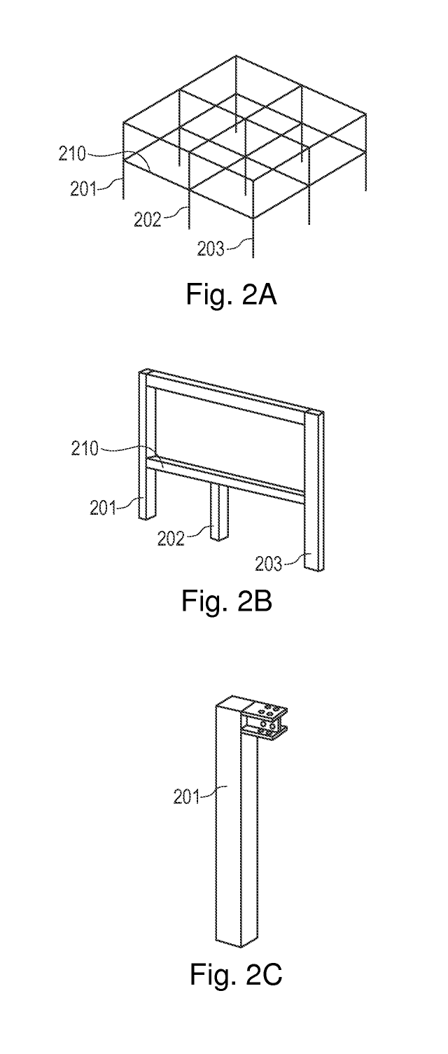

Designing is performed using a CAD system handling three-dimensional shapes and attributes in the order of outline design, basic design, and detailed design, respectively. The level of detail of the data to be represented may be different depending on the progress of the design. For example, the data indicative of a column of a structure is represented by a single straight line in the outline design in an initial stage of the designing (FIG. 2a). It is then represented by the shape of shape steel with a section in the shape of a square, “H,” or “L” in the basic design (FIG. 2b). Furthermore, the detailed design at the final stage is represented by data to which shaped portions such as a protrusion and a bolt hole in a connection with a beam are added (FIG. 2c). While the detailed design is configured as the data divided with respect to each part as a unit of production, in the initial outline design, a plurality of columns arranged linearly may be combined to be represented as a single straight line.

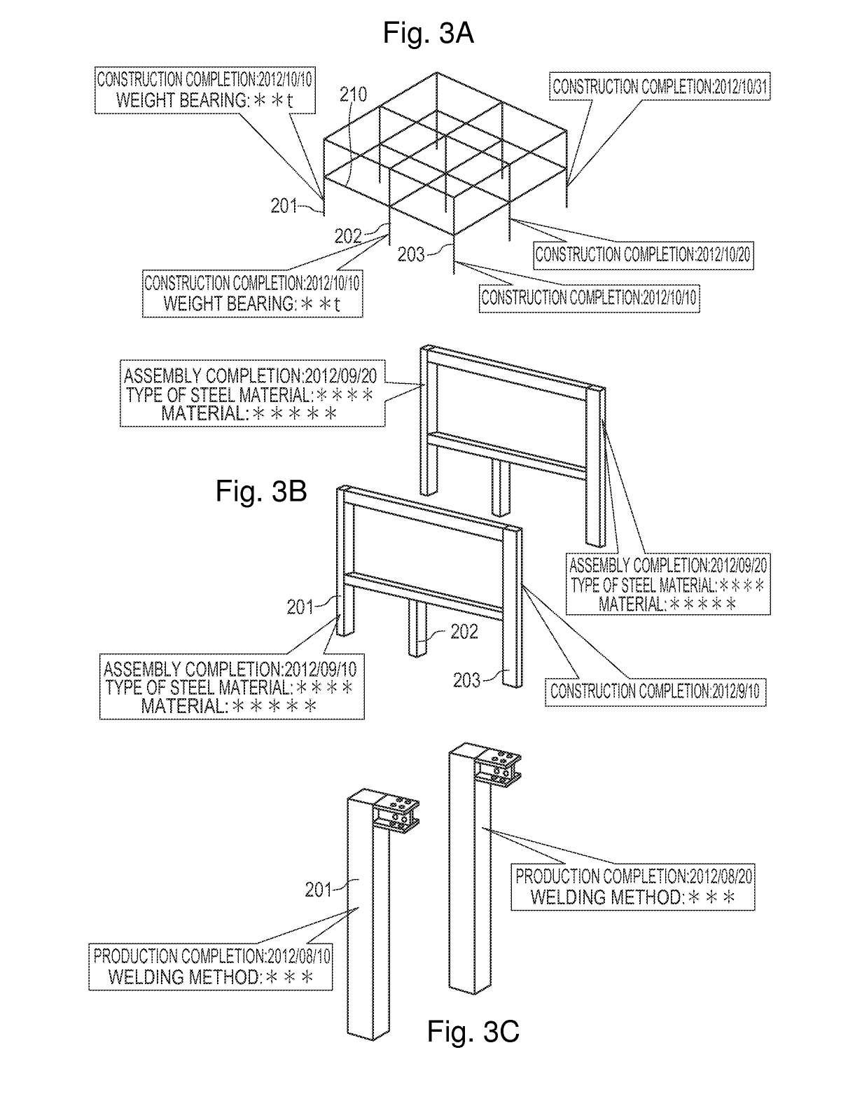

Moreover, a name, a part number, a material, a designer name, a date of design, a date of production, a date of assembly, a date of construction, and the like are attached as attribute data to an element (part) constituting the data. An example of the attribute data is visually shown in FIG. 3. Each piece of the shape data corresponds to that in FIG. 2 except that a completion date of construction and a weight bearing are attached as the attributes of each column in (a). Similarly, a completion date of assembly, a type of steel material, and a material are attached as the attributes in (b), and a completion date of production and a welding method are attached as the attributes in (c). Shown here are parts of the typical attribute data required for the outline design, the basic design and the detailed design, respectively, and the present invention does not limit the attribute items and the representation method to this form.

Assuming the process and the object of design described above, this embodiment can be applied both between the outline design and the basic design and between the basic design and the detailed design. Hereinafter, the description is focused on a case where it is applied between the basic design and the detailed design. It should be noted that, although the description is given assuming a typical scene of use in this embodiment, the applicable scene is not limited thereto. The present invention encompasses, for example, CAD data with different design viewpoints such as CAD data of strength design and CAD data of electric design, and a device for simply processing between the data before and after design change.

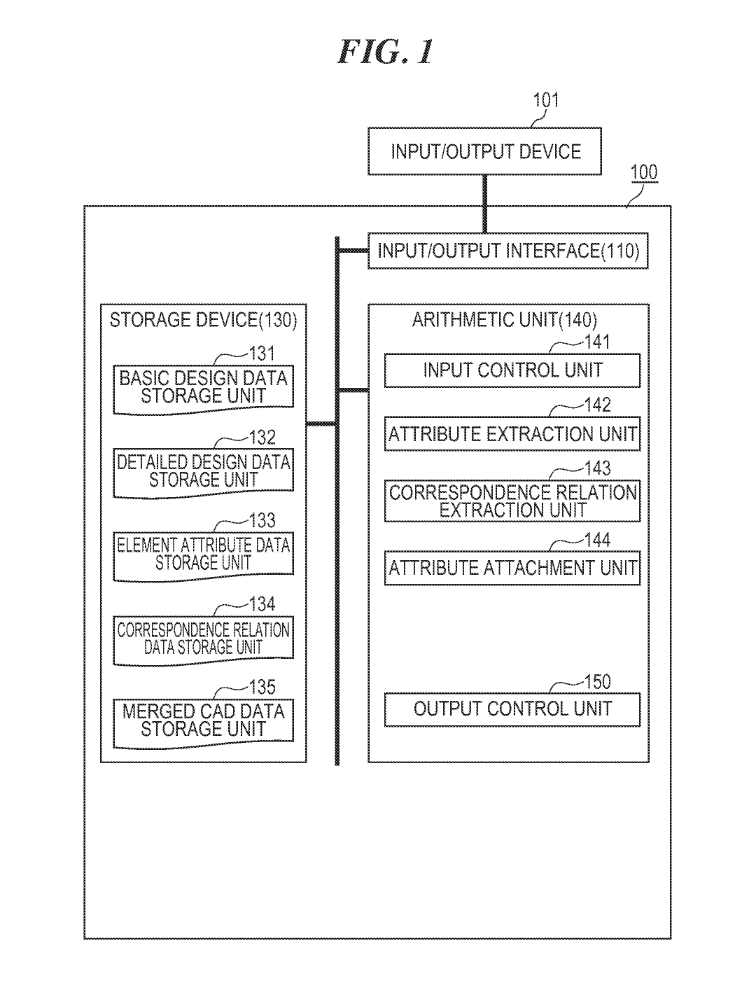

FIG. 1 is a schematic diagram of a processing device (100) according to the present invention and peripheral devices.

An input/output device (101) performs input of the CAD data of the basic design and the CAD data of the detailed design, instruction of output, and output of created data, and it is preferably constituted by a general input/output device of a calculator such as a keyboard, a mouse, a display, and a printer. It should be noted that the device configuration is not limited thereto.

An input/output interface (110) is a part of the processing device (100), and exchanges data with the input/output device (101).

A storage device (130) is a portion that stores therein various data, and constituted by the following storage units.

A basic design data storage unit (131) is a portion that stores therein the CAD data of the basic design input from the input/output device (101). In this embodiment, it is constituted by data of shape, various attribute data attached to the shape, data indicative of group relationship and relative relationship of individual shape data, and the like, processed by a general CAD system.

A detailed-design data storage unit (132) is a portion that stores therein the CAD data of the detailed design input from the input/output device (101). In this embodiment, as with the basic design data storage unit (131), it is constituted by the data of shape, various attribute data attached to the shape, the data indicative of the group relationship and the relative relationship of the individual shape data, and the like, processed by a general CAD system. The basic design data storage unit (131) and the detailed-design data storage unit (132) may store therein the data represented in an identical format or may store therein the data in different formats. Examples of the different formats include a format showing a circle in a three-dimensional space with a center point, a direction of a plane, and a radius, and a format showing the circle with the center point, the direction of the plane, and a diameter. Even with the different formats, the identical shape can be represented. It should be noted that the present invention does not restrict the format of the data stored in the basic design data storage unit (131) and the detailed-design data storage unit (132).

An element attribute data storage unit (133) is a portion that stores therein data of an attribute attached to an element included in the CAD data of the basic design created by an attribute extraction unit (142) to be described later.

A correspondence relation data storage unit (134) is a portion that stores therein data indicative of a correspondence relation between an element included in the CAD data of the basic design and an element included in the CAD data of the detailed design created by a correspondence relation extraction unit (143) to be described later.

A merged CAD data storage unit (135) is a portion that stores therein data including the CAD data of the detailed design and an attribute included in the CAD data of the basic design attached thereto, created by an attribute attachment unit (144) to be described later.

An arithmetic unit (140) is constituted by the following processing units that process the data input from the input/output interface (110) and the data stored in the storage device (130).

An input control unit (141) is a portion that classifies the data input from the input/output device into a command, data, and the like, and transfers them to each portion of the storage device and the arithmetic unit. To name especially important data, it transfers the CAD data of the basic design to the basic design data storage unit (131) and transfers the CAD data of the detailed design to the detailed-design data storage unit (132).

The attribute extraction unit (142) is a portion that extracts the attribute data attached to each element in the basic design data stored in the basic design data storage unit (131) and records the result in the element attribute data storage unit (133).

The correspondence relation extraction unit (143) is a portion that extracts the correspondence relation of the element from each element in the basic design data stored in the basic design data storage unit (131) and each element in the detailed design data stored in the detailed design data storage unit (132), creates the resulting data, and records it in the correspondence relation data storage unit (134).

The attribute attachment unit (144) is a portion that, for each piece of the attribute data stored in the element attribute data storage unit (133), identifies the corresponding element in the CAD data of the detailed design stored in the detailed-design data storage unit (132) using the correspondence relation stored in the correspondence relation data storage unit (134), attaches the above attribute to the element, and records it in the merged CAD data storage unit (135).

An output control unit (150) is a portion that performs control to output the stored data to each portion in the storage device (130) and transfers the data to the input/output device (101). Its main processing is to transfer the CAD data of the detailed design attached with the attribute stored in the merged CAD data storage unit (135) to an output device. The data is preferably in the same format as the input CAD data of the detailed design, and can be read and displayed by the CAD system that created the CAD data of the detailed design. It should be noted that, however, the present invention is not limited to the identical format.

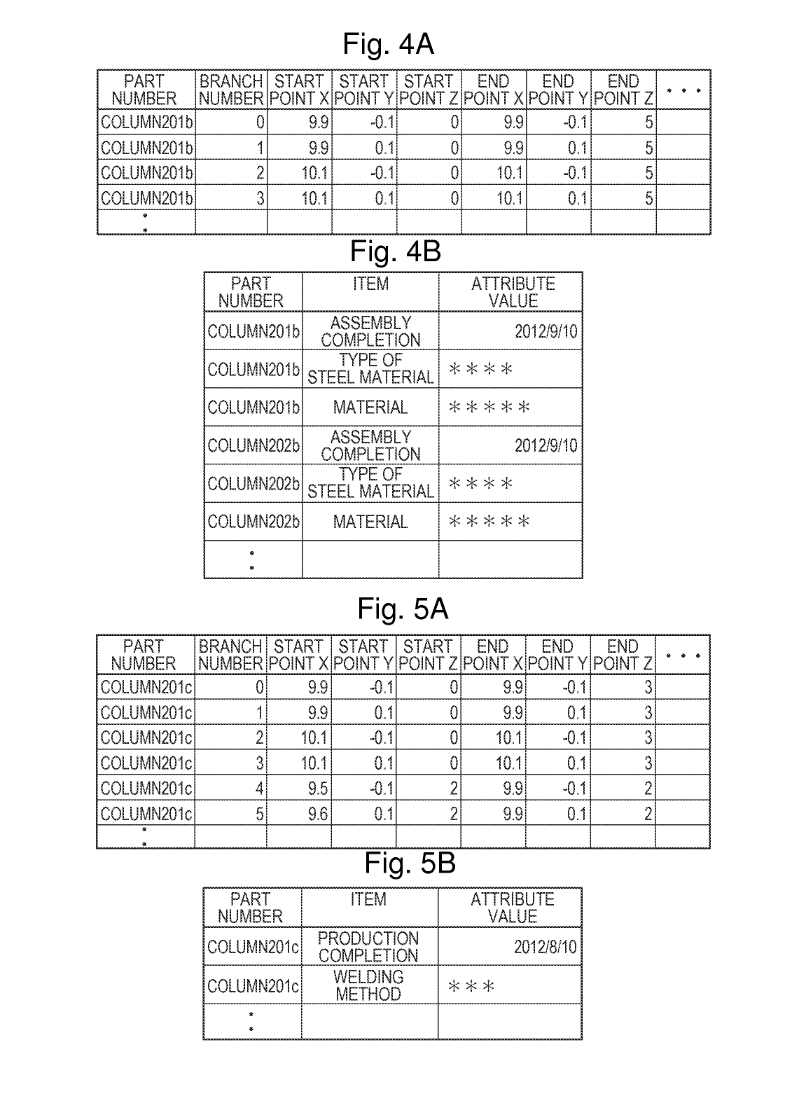

FIG. 4 shows an example of the table format of the basic design data and the data stored in the basic design data storage unit (131). Shown in (a) is a shaped portion. One row represents one straight line, indicating that a column 201 in FIG. 3(b) is constituted by a plurality of straight lines. The part number is used to control each element in the basic design data; usually the number is different from element to element, but the present invention does not limit the way of providing the number to the aforementioned one. In this example, different numbers are provided with respect to each element (part) as a shape. A branch number is used to distinguish among a plurality of pieces of data provided with an identical part number. To represent the column 201 by the data on a plurality of rows, each row is distinguished by a branch number. A start point and an end point indicate coordinate positions at both ends of the constituent straight line. Other various data can also be added to the basic design data. It is also possible to use such data as a curved line, a plane, a solid having a volume and the like other than the straight line.

FIG. 4(b) shows the attribute data attached to the shape. One row represents one item of the attribute data, and an item of the attribute and a value of the attribute are recorded in the element (part) of the shape represented by the part number. For example, it means that an item of “assembly completion” and an attribute of a value of 2012/9/10 are attached to the element (part) having the part number of the column 201b. It is also possible to attach a plurality of attributes to a single element, which can be expressed as a plurality of rows of data.

FIG. 5 shows an example of the table format of the detailed design data and the data stored in the detailed-design data storage unit (132). In this example, the table format is exactly same as the case of the basic design data. As described above, the present invention is not limited to such a case of the same format.

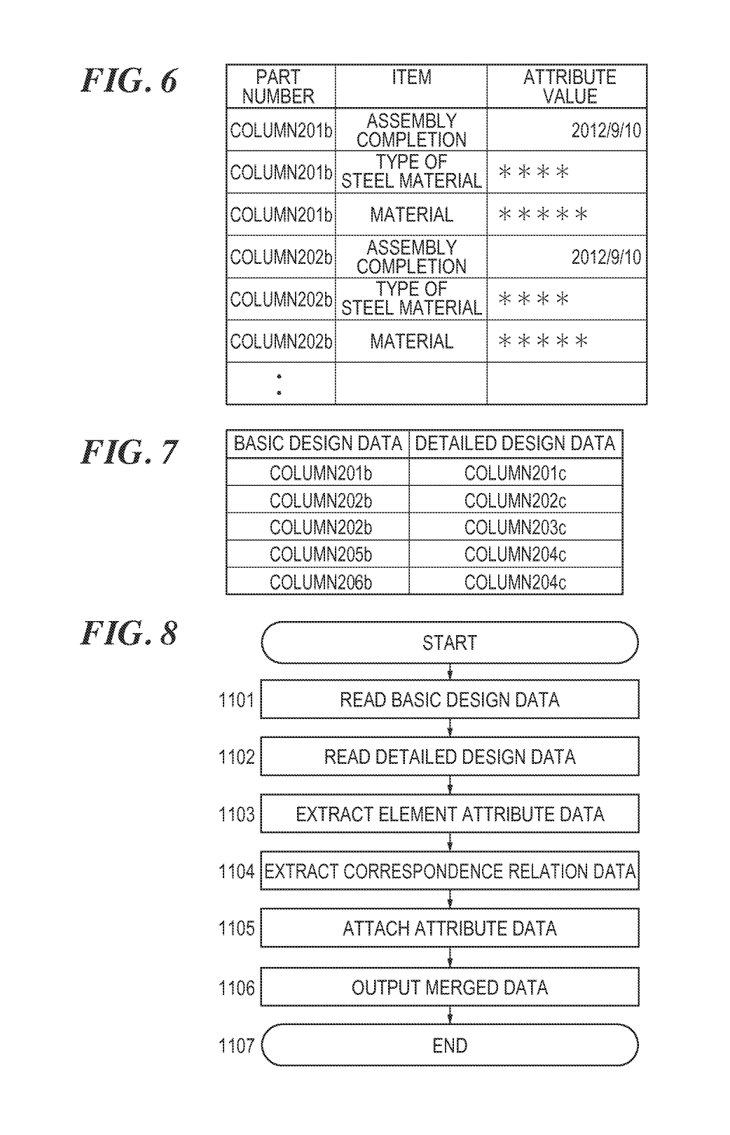

FIG. 6 shows an example of the table format of the element attribute data and the data stored in the element attribute data storage unit (133). In this example, both the table format and the data are identical to the attribute data portion of the basic design data shown in FIG. 4(b). They match because this expression form is common as a form for representing the attribute, and the present invention is not limited to this form.

FIG. 7 shows an example of the table format of the correspondence relation data and the data stored in the correspondence relation data storage unit (134). One row represents one pair of the correspondence relation, which shows, for example, that an element (part) in which the part number of the basic design data is column 201b corresponds to an element (part) in which the part number of the detailed design data is column 201c. When there is a correspondence relation of one to many, many to one, or many to many, it is developed into individual correspondence relations to be represented in a plurality of rows.

FIG. 8 is a flow diagram of the process performed by the processing device (100). First, the input/output interface (110) receives the CAD data of the basic design from the input/output device (101) and records it in the basic design data storage unit (131) (1101). Next, the input/output interface (110) receives the CAD data of the detailed design from the input/output device (101) and records it in the detailed-design data storage unit (132) (1102). Next, the attribute extraction unit (142) extracts the attribute data attached to each element of the basic design data stored in the basic design data storage unit (131) and records the result in the element attribute data storage unit (133) (1103). Next, the correspondence relation extraction unit (143) extracts the correspondence relation of the element from each element of the basic design data stored in the basic design data storage unit (131) and each element of the detailed design data stored in the detailed-design data storage unit (132), and records the result in the correspondence relation data storage unit (134) (1104). Then the attribute attachment unit (144), for each piece of the attribute data stored in the element attribute data storage unit (133), identifies the corresponding element in the CAD data of the detailed design stored in the detailed-design data storage unit (132) using the correspondence relation stored in the correspondence relation data storage unit (134), attaches the above attribute to the element, and records it in the merged CAD data storage unit (135) (1105). Lastly, the output control unit (150) transfers the CAD data of the detailed design attached with the attribute stored in the merged CAD data storage unit (135) to the input/output device (101) through the input/output interface (110) (1106).

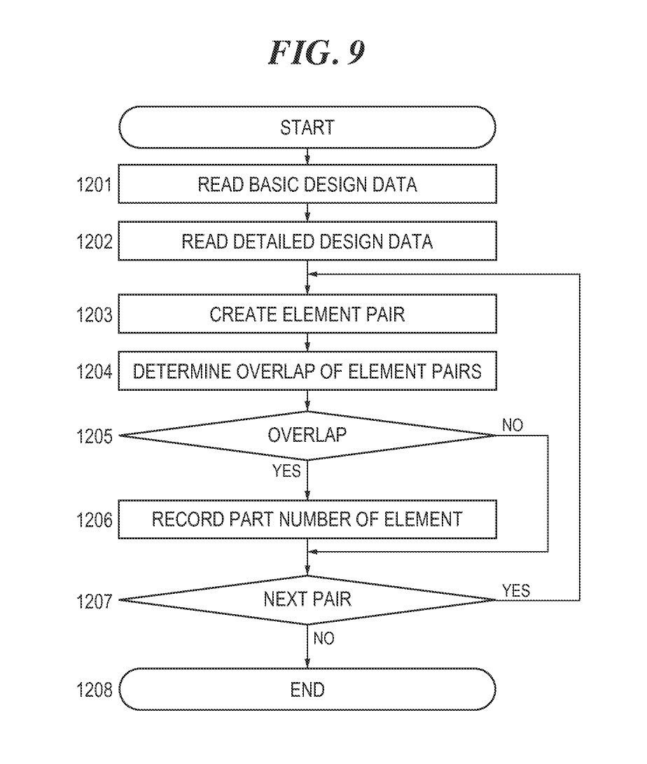

FIG. 9 is a detailed flow diagram of the process (1104) performed by the correspondence relation extraction unit (143). First, the basic design data is read from the basic design data storage unit (131) (1201). Next, the detailed design data is read from the detailed-design data storage unit (132) (1202). Next, a pair of an element included in the basic design data and an element included in the detailed design data is created (1203), and it is determined whether there is a spatial overlap of the two elements (1204). As a result, if there is any overlap, the part numbers of the elements forming the pair are recorded in the correspondence relation data storage unit (134) (1206). The process from 1203 to this point is performed on every combination of pairs (1207). Although it is desirable that the data of the basic design data and the data of the detailed design are arranged so that the corresponding elements are in the same coordinate and in the same direction in advance, if they are different, they can be matched by performing a coordinate conversion before this process. In this embodiment, this determination method is employed assuming that the elements are likely to correspond to one another if there is the spatial overlap. This method can be applied not only to the case of one-to-one corresponding elements, but also to the cases of one to many, many to one, and many to many. It should be noted that non-corresponding elements may only infrequently have an overlap, even if the spatial overlap is strictly determined. Therefore, another method is also prepared in which a user gives an instruction to delete an extra attribute depending on the application.

The determination of existence of the spatial overlap can be performed by a method of “interference check” widely known in the field of graphic information processing. This is because the interference means the existence of a spatially overlapping portion. In this embodiment, it is also possible to simplify the processing using a simple method. For example, as for a range where each element exists, the determination of an actual element can be replaced by obtaining maximum coordinate values and minimum coordinate values in the directions of three orthogonal axes, e.g., x, y, and z directions in the three-dimensional space and determining whether there is a spatial overlap in a rectangular parallelepiped determined by the values obtained above.

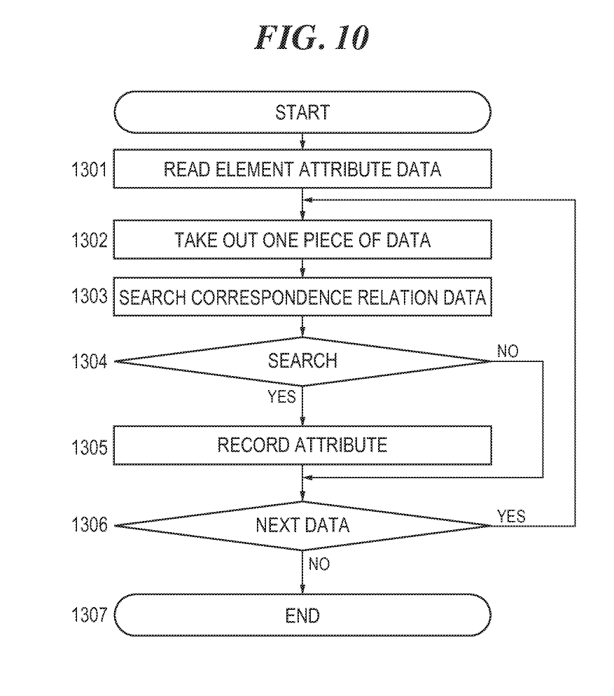

FIG. 10 is a detailed flow diagram of the process (1105) performed by the attribute attachment unit (144). First, the element attribute data stored in the element attribute data storage unit (133) is read (1301). Next, each piece of data is taken out sequentially (1302), and its data with the part number identical to an item in the basic design data of the correspondence relation data stored in the correspondence relation data storage unit (134) is searched (1303). For example, when the first piece of data “column 201b, assembly completion, 2012/9/10” shown in FIG. 6 is taken out, a piece of data showing “column 201b” in the field of the basic design data in FIG. 7 is searched. It should be noted that, in this search, there can be no applicable data or more than one piece of data can be found. When there are one or more pieces of applicable data (1304), an attribute item and an attribute value of the data are recorded in the element of the corresponding part number of the detailed design data (1305). In the above example, because “column 201c” in the detailed design data is applicable, the data showing the attribute item “assembly completion” and the attribute value “2012/9/10” is recorded in the element having the part number “column 201c” in the detailed design data. The process from 1302 to this point is performed on every piece of the element attribute data (1306).

When no corresponding data is found in the search in the correspondence relation data (1303), there is a risk of omitting the attribute data, and therefore there can be provided other output means for representing the attribute data of the element in the basic design data without the attribute data attached thereto. To collectively present a location where the data was attached at this time, there is also a method of duplicating the element data in the original basic design data including the shaped portion and the attribute portion on the detailed design data. In this method, even if any element is omitted, the omitted element is clear. Moreover, it is also preferable to skip recording the attribute data in the detailed design data if the data of the same attribute item and attribute value already exist. This is to avoid recording redundant data when the same attribute has already been recorded at the stage of the detailed design.

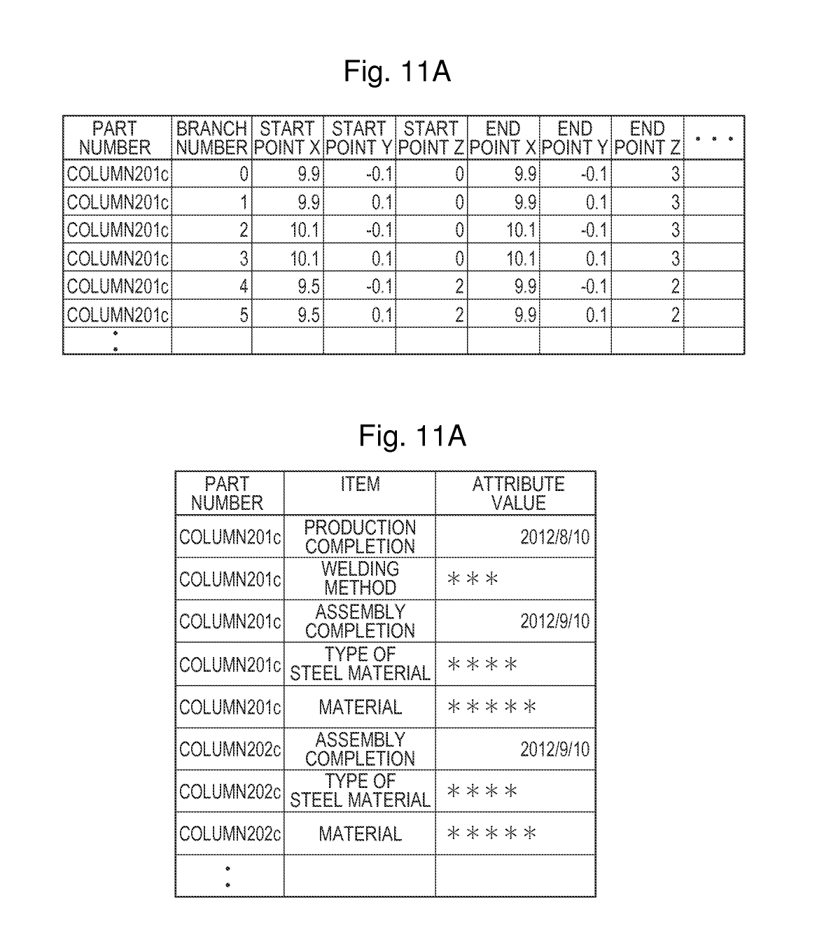

After performing the processing described above, the attribute is additionally recorded in the original detailed design data and the very original data can be lost. Thus, the full detailed design data may be previously duplicated and recorded in the merged CAD data storage unit (135) before performing the processing by the attribute attachment unit (144) and the above processing may be performed on the data. FIG. 11 shows an example of the table format of the merged data and the data recorded in the merged CAD data storage unit (135) when the processing described above is performed on the data used in the description. In this example, the table format is exactly the same as the cases of the basic design data and the detailed design data. As described above, the present invention is not limited to such a case of the same format. The shaped portion in (a) stays the same as in the detailed design data in FIG. 5. The attribute portion in (b) is the data including the attribute portion of the detailed design data in FIG. 5(b) and the attribute portion of the basic design data in FIG. 4(b) added thereto.

When the device of this embodiment is operated, the following instruction, result, and the like are output to the user. When firstly reading the basic design data (1101) and subsequently reading the detailed design data (1102), a message is output to have the user specify the data. The data is preferably specified by the name or the like, and it may be selected from among candidates. It may be recorded in the device, or it may be recorded remotely and read via a communication path.

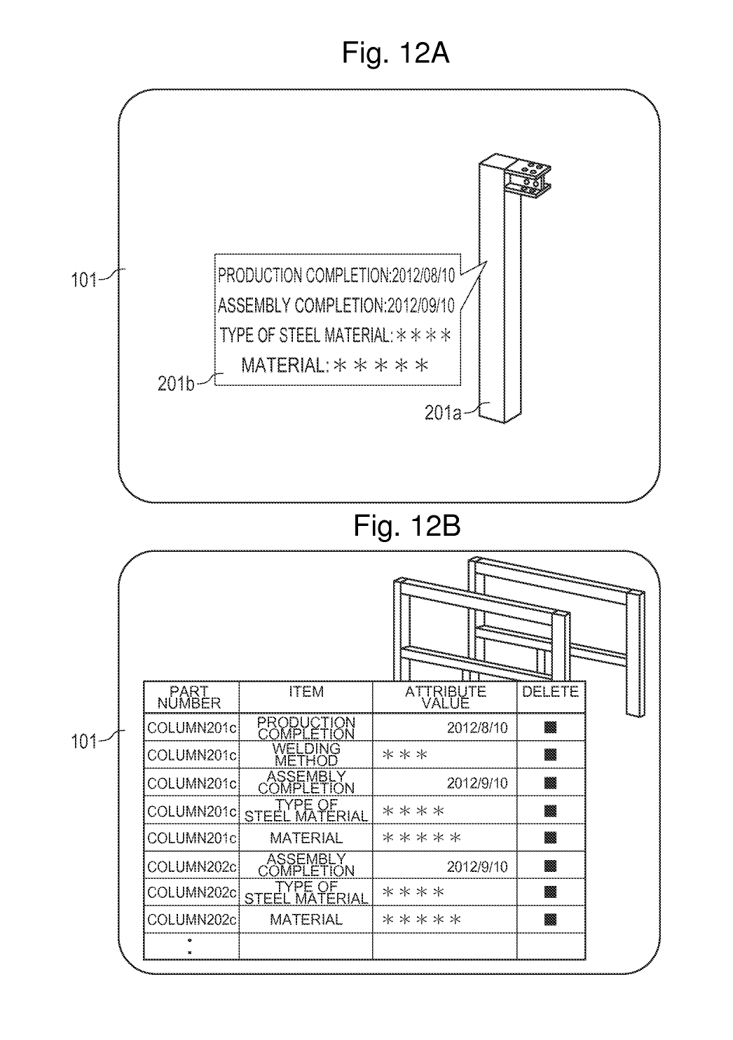

FIG. 12 is an example of the result displayed on a display when the merged data is output at the end of the processing (1106 in FIG. 8). Shown in (a) is an example of the state in which the merged attribute data is displayed along with the shape data. Shown in (b) is similar except that the attribute data is displayed in a list. When the user gives an instruction to select the attribute data, the display color of the shape data to which the attribute is attached is changed. When the user gives an instruction to select the shape data, the display color of the attribute data attached to the shape data is changed. When a button displayed on a column of “delete” is selected, unnecessary attribute data can be deleted. Although this is an example of the case where the merged CAD data is displayed on the input/output device connected to the processing device (100), it is also preferable to obtain such display on the CAD system after the merged CAD data is output as a file, for example, and transferred to the CAD system or the like.

The embodiment described above includes a part constituted by a plurality of elements, an input/output interface 110 that is means for reading a plurality of pieces of three-dimensional CAD data in a processing device for the three-dimensional CAD data having attribute data associated with each of the plurality of parts, an attribute extraction unit 142 that extracts the attribute data from basic design data being first CAD data, a correspondence relation extraction unit 143 that extracts correspondence relation using positional information included in the basic design data and detailed design data being second CAD data, an attribute attachment unit 144 that provides the detailed design data with the attribute data extracted from the basic design data based on the extracted correspondence relation extracted, and an output control unit 150 that outputs the data provided with the attribute data.

This provides means for identifying a corresponding element between CAD data of one design and CAD data of another design and duplicating the attribute data recorded in the CAD data of the first design to the CAD data of the other design using the relation. According to such a processing device, it is possible to optimize the merging operation of the CAD data jointly designed by a plurality of persons in charge. It is also possible to avoid an omission and an error in the merging operation of the attributes between the CAD data.

Although it is assumed that the attribute data is associated with “a part constituted by a plurality of elements,” this naturally includes the case where there are other “plurality of parts” without the attribute data associated therewith. It is needless to say that the above effects can be obtained.

Moreover, although the correspondence relation data is extracted after extracting the attribute data in the embodiment, the order has no dependence but the same effect can be obtained in the reverse order.

It should be noted that the present invention is not limited to the embodiment described above but includes various modifications. For example, the above embodiment is described in detail for clearly explaining the present invention, and it is not limited to necessarily include all the configurations mentioned above. Moreover, it is possible to replace a part of a configuration in one embodiment with a configuration in another embodiment, and it is also possible to add a configuration in one embodiment to a configuration in another embodiment. Furthermore, it is also possible to add a configuration in another embodiment to, delete, or replace a part of a configuration in each embodiment.

Moreover, each configuration, function, processing unit, processing means, and the like described above may be, partially or fully, implemented by hardware, for example, by designing it using an integrated circuit and the like. Furthermore, each configuration, function, and the like maybe implemented by software interpreting and executing a program that implements each function. The information such as a program, a table, a file, measurement information, computational information and the like for implementing each function can be placed in a recording device such as a memory, a hard disk, an SSD (Solid State Drive), or the like, or a recording medium such as an IC card, an SD card, a DVD, or the like. Thus, each process and each configuration can implement each function as a processing section, a processing unit, a program module, or the like.

### LIST OF REFERENCE SIGNS

100 Processing device
101 Input/output device
110 Input/output interface
130 Storage device
131 Basic design data storage unit
132 Detailed design data storage unit
133 Element attribute data storage unit
134 Correspondence relation data storage unit
135 Merged CAD data storage unit
140 Arithmetic unit
141 Input control unit
142 Attribute extraction unit
143 Correspondence relation extraction unit
144 Attribute attachment unit
150 Output control unit

1. A processing device for three-dimensional CAD data having a plurality of elements and attribute data associated with each of the plurality of elements, comprising:
means for reading a plurality of pieces of CAD data;
attribute extraction means for extracting the attribute data from first CAD data;
correspondence relation extraction means for extracting a correspondence relation using positional information included in the first CAD data and second CAD data;
attribute attachment means for attaching the attribute data extracted from the first CAD data to the second CAD data based on the extracted correspondence relation; and
means for outputting the data provided with the attribute data.

2. The processing device for three-dimensional CAD data according to claim 1,
wherein the correspondence relation extraction means determines whether there is a spatially overlapping region of the elements.

3. The processing device for three-dimensional CAD data according to claim 2,
wherein the correspondence relation extraction means performs coordinate conversion so that coordinates of the corresponding elements match before determining whether there is a spatially overlapping region of the elements.

4. The processing device for three-dimensional CAD data according to claim 1, comprising:
means for outputting attribute data of the element in the first CAD data to which the attribute attachment means did not attach the attribute data.

5. A method of processing three-dimensional CAD data having a plurality of elements and attribute data associated with each of the plurality of elements, comprising:
reading a plurality of pieces of CAD data;
extracting the attribute data from first CAD data;
extracting a correspondence relation using positional information included in the first CAD data and second CAD data;
attaching the attribute data extracted from the first CAD data to the second CAD data based on the extracted correspondence relation; and
outputting the data provided with the attribute data.

6. The method of processing three-dimensional CAD data according to claim 5,
wherein the correspondence relation is extracted by determining whether there is a spatially overlapping region of the elements.

7. The method of processing three-dimensional CAD data according to claim 6,
wherein coordinate conversion is performed so that coordinates of the corresponding elements match before determining whether there is a spatially overlapping region of the elements.

8. The method of processing three-dimensional CAD data according to claim 5, comprising:
outputting attribute data of the element in the first CAD data to which the attribute data was not attached.
